(19) United States
(12) Patent Application Publication
(10) Pub. No.: US 2026/0099348 A1
(43) Pub. Date: Apr. 9, 2026

(54) RETAINING THE NON-VOLATILE MEMORY EXPRESS CACHED DATA DURING VIRTUAL MACHINE MIGRATION IN A CLOUD SETUP

(71) Applicant: INTERNATIONAL BUSINESS MACHINES CORPORATION, ARMONK, NY (US)

(72) Inventors: Rizwan Sheikh Abdulla, Bangalore (IN); Ravikishore Krishnamurthy, Bangalore (IN); Veeresh Jumanal, BANGALORE (IN); Shivarudrappa Satyanaik, Bengaluru (IN)

(21) Appl. No.: 18/907,430

(22) Filed: Oct. 4, 2024

(51) Int. Cl. G06F 9/455; G06F 13/42

(52) U.S. Cl. CPC G06F 9/45558; G06F 13/4234; G06F 2009/4557; G06F 2009/45583

(57) ABSTRACT

Virtual machine migration includes caching a data storage in the source computing system using a non-volatile memory express protocol. The source computing system includes a first virtual machine. A target computing system is identified for migration of the first virtual machine to a second virtual machine in the target computing system. A virtual persistent memory device is provided to the first virtual machine. A persistent cache disk associated with the first virtual machine is generated. The cache content in the persistent cache disk is generated using the non-volatile memory express protocol. The cache content of the persistent cache disk that was generated using the non-volatile memory express protocol is migrated to the virtual persistent memory device. A copy of the virtual persistent memory device is migrated to a copy of the persistent cache disk generated in a second virtual machine in the target computing system.

### BACKGROUND

### Technical Field

The present disclosure generally relates to information and communication technology, and more particularly, to retaining the non-volatile memory express cached data during virtual machine migration in a cloud setup.

### Description of the Related Art

NVMe (Non-Volatile Memory Express) is a protocol designed to use the PCI Express (PCIe) bus to connect SSD (solid-state drive) storage to servers or CPUs. NVMe was created by a consortium of large IT providers in 2008 to provide improved speed and performance.

NVMe can perform parallel input/output (I/O) operations with multicore processors to facilitate high throughput. In an Advanced Host Controller Interface (AHCI), the previous PCIe interface for SSD, must communicate with the SAS/SATA controller. The NVMe communicates directly with the host CPU.

NVM express was developed from 2008 to 2011 to replace Serial Advanced Technology Attachment (SATA) and Serial Attached SCSI (SAS) protocols. NVMe's improvements in latency and performance over its competitors contributed to the development of other important technologies, including the Internet of Things (IoT), artificial intelligence (AI) and machine learning (ML).

Today, users demand faster response times than ever from their applications. The NVMe protocol was built to deliver a next-generation, high-performance, high-bandwidth and low-latency experience, regardless of the type of application a user is deploying.

NVMe drives can run tens of thousands of parallel command queues and run programs at faster speeds than drives connected by using SCSI protocol, which can only deploy a single command queue. The connection method is independent of the protocol; for example, NVMe PCIe can connect a single drive via a PCIe link running the NVMe protocol.

NVMe was built for high-performance, non-volatile storage media, making it ideal for today's demanding, compute-intensive environments like graphics editing software, cloud computing environments, firmware and large databases. NVMe deals with enterprise workloads swiftly and efficiently with a smaller infrastructure footprint and less power than SCSI.

“Migration”, refers to the process of moving a running virtual machine (VM) between different physical machines without disconnecting the client or application. Memory, storage, and network connectivity of the virtual machine are transferred from the original guest machine to the destination.

Migration generally includes multiple phases. In the pre-copy phase, the Hypervisor copies all the memory pages from source to destination while the VM is still running on the source. After the pre-copy phase, the VM will be paused on the source host, the last remaining pages will be copied to the destination, and the VM will be resumed at the destination.

### SUMMARY

According to an embodiment of the present disclosure, a computer program product for virtual machine migration is provided. The computer program product comprises a computer readable storage medium having program instructions embodied therewith. An execution of the program instructions cause a processor to cache a data storage in the source computing system using a non-volatile memory express protocol. The source computing system includes a first virtual machine. A target computing system is identified for migration of the first virtual machine to a second virtual machine in the target computing system. A virtual persistent memory device is provided to the first virtual machine. A persistent cache disk associated with the first virtual machine is generated. The cache content in the persistent cache disk is generated using the non-volatile memory express protocol. The cache content of the persistent cache disk that was generated using the non-volatile memory express protocol is migrated to the virtual persistent memory device. A copy of the virtual persistent memory device is migrated to a copy of the persistent cache disk generated in a second virtual machine in the target computing system.

According to an embodiment of the present disclosure, a computer implemented method for virtual machine migration is provided. The method includes caching a data storage in the source computing system using a non-volatile memory express protocol. The source computing system includes a first virtual machine. A target computing system is identified for migration of the first virtual machine to a second virtual machine in the target computing system. A virtual persistent memory device is provided to the first virtual machine. A persistent cache disk associated with the first virtual machine is generated. The cache content in the persistent cache disk is generated using the non-volatile memory express protocol. The cache content of the persistent cache disk that was generated using the non-volatile memory express protocol is migrated to the virtual persistent memory device. A copy of the virtual persistent memory device is migrated to a copy of the persistent cache disk generated in a second virtual machine in the target computing system.

According to an embodiment of the present disclosure, a source computing system includes a processor operating a hypervisor and a first virtual machine. A memory is coupled to the processor. The memory stores instructions to cause the processor to perform acts comprising caching a data storage in the source computing system using a non-volatile memory express protocol. The source computing system includes a first virtual machine. A target computing system is identified for migration of the first virtual machine to a second virtual machine in the target computing system. A virtual persistent memory device is provided to the first virtual machine. A persistent cache disk associated with the first virtual machine is generated. The cache content in the persistent cache disk is generated using the non-volatile memory express protocol. The cache content of the persistent cache disk that was generated using the non-volatile memory express protocol is migrated to the virtual persistent memory device. A copy of the virtual persistent memory device is migrated to a copy of the persistent cache disk generated in a second virtual machine in the target computing system.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a computing environment for virtual machine migration, consistent with an illustrative embodiment.

FIG. 2 is a block diagram of an architecture for virtual machine migration, consistent with an illustrative embodiment.

FIG. 3 is a diagrammatic view of a system for retaining cached data during virtual machine migration, according to an embodiment.

FIG. 4 is a flowchart of a method for retaining cached data during virtual machine migration, according to an embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Definitions

Virtual Machine, as used herein, refers to the virtualization or emulation of a computer system.

“NVM”, as used herein, refers to non-volatile memory.

NVM Express (NVMe), as used herein, refers to an open, logical-device interface specification for accessing a computer's non-volatile storage media.

Persistent Memory (PMEM), as used herein, refers to any method or apparatus for efficiently storing data structures such that they can continue to be accessed using memory instructions or memory APIs even after the end of the process that created or last modified them.

Live Partition Mobility, as used herein, refers to a chargeable live migration feature for servers that allows a running local partition to be relocated from one system to another.

### Overview

The present disclosure generally relates to retaining cache data during a migration involving virtual machines. The subject technology retains the cached contents of storage devices (for example, of hard disks) on the source computing system when migrated over to a target computing system by using virtual persistent memory (vPMEM). Generally, when migrating a virtual machine from a source computing system to a target computing system, recently used data from data storage devices will be cached into the cache device. All future read request data are served from the cached data on the Non-Volatile Memory Express (NVMe) protocol backed device, resulting in improvement of application performance. However, if a virtual machine being migrated is using the Non-Volatile Memory Express (NVMe) protocol as a cached media for data storage devices, the cached data is not retained in the target computing system after successful completion of a migration operation. This is because the NVMe protocol does not have stand-alone capacity to retain cached data during migration. This results in the need for freshly caching data in storage data devices within the target computing system after migration is complete.

Having to re-cache data for every migration places an undue burden on networks using virtual machines. Some networks commonly migrate virtual machines from one computing system to another for various purposes. Accordingly, re-caching data that is lost during migration requires additional resources to locate the data and time is lost in getting the new virtual machine instance up into operation as the new instance waits for the cached data.

According to an embodiment of the present disclosure, a computer program product for virtual machine migration is provided. The computer program product comprises a computer readable storage medium having program instructions embodied therewith. An execution of the program instructions causes a processor to cache a data storage in the source computing system using a non-volatile memory express protocol. The source computing system includes a first virtual machine. A target computing system is identified for migration of the first virtual machine to a second virtual machine in the target computing system. A virtual persistent memory device is provided to the first virtual machine. A persistent cache disk associated with the first virtual machine is generated. The cache content in the persistent cache disk is generated using the non-volatile memory express protocol. The cache content of the persistent cache disk that was generated using the non-volatile memory express protocol is migrated to the virtual persistent memory device. A copy of the virtual persistent memory device is migrated to a copy of the persistent cache disk generated in a second virtual machine in the target computing system. As will be appreciated, by using virtual persistent memory, cached data in a storage device, such as a hard disk, can be retained during the migration process when used in cooperation with a device using the non-volatile memory express protocol. Where cached data is normally lost during migration to a target system, a persistent cache disk using the virtual persistent memory can conserve the cached data. The cached data can be retrieved on the target system by accessing the copy of the virtual persistent memory device in the copy of the persistent cache disk.

According to one embodiment, which can be combined with one or more previous embodiments, the execution of the program instructions further causes a hypervisor in the source computing system to provide memory pages backing up an instance of the virtual persistent memory device. The backup instance of the virtual persistent memory device provides a safeguard against losing the cache during migration as well as a source for accessing the cache data during migration.

According to one embodiment, which can be combined with one or more previous embodiments, the migration of the cache content of the persistent cache disk to the virtual persistent memory device occurs during the migration of the copy of the virtual persistent memory device to the copy of the persistent cache disk generated in the second virtual machine in the target computing system. In this manner, the cache data is preserved and the risk of loss on the source side is minimized.

According to one embodiment, which can be combined with one or more previous embodiments, the execution of the program instructions further causes the computing device to cache additional memory storage devices in the source computing system in the copy of the persistent cache disk generated in the second virtual machine in the target computing system. This feature leverages the availability of the virtual persistent memory to carry cache data from different storage sources to the target system.

According to one embodiment, which can be combined with one or more previous embodiments, the execution of the program instructions further causes the computing device to de-configure, from the first virtual machine, the persistent cache disk that was generated using the non-volatile memory express protocol and the virtual persistent memory device. By de-configuring the persistent cache disk, a clean-up feature is provided that frees up data storage space within the source computing system once migration is done.

According to one embodiment, which can be combined with one or more previous embodiments, the data storage device is one of a hard disk, flash memory, or solid-state drive.

According to an embodiment of the present disclosure, a computer implemented method for virtual machine migration is provided. The method includes caching a data storage in the source computing system using a non-volatile memory express protocol. The source computing system includes a first virtual machine. A target computing system is identified for migration of the first virtual machine to a second virtual machine in the target computing system. A virtual persistent memory device is provided to the first virtual machine. A persistent cache disk associated with the first virtual machine is generated. The cache content in the persistent cache disk is generated using the non-volatile memory express protocol. The cache content of the persistent cache disk that was generated using the non-volatile memory express protocol is migrated to the virtual persistent memory device. A copy of the virtual persistent memory device is migrated to a copy of the persistent cache disk generated in a second virtual machine in the target computing system. As will be appreciated, by using virtual persistent memory, cached data in a storage device, such as a hard disk, can be retained during the migration process when used in cooperation with a device using the non-volatile memory express protocol. Where cached data is normally lost during migration to a target system, a persistent cache disk using the virtual persistent memory can conserve the cached data. The cached data can be retrieved on the target system by accessing the copy of the virtual persistent memory device in the copy of the persistent cache disk.

According to one embodiment, which can be combined with one or more previous embodiments, the method further includes a hypervisor in the source computing system providing memory pages backing up an instance of the virtual persistent memory device. The backup instance of the virtual persistent memory device provides a safeguard against losing the cache during migration as well as a source for accessing the cache data during migration.

According to one embodiment, which can be combined with one or more previous embodiments, the migration of the cache content of the persistent cache disk to the virtual persistent memory device occurs during the migration of the copy of the virtual persistent memory device to the copy of the persistent cache disk generated in the second virtual machine in the target computing system. In this manner, the cache data is preserved and the risk of loss on the source side is minimized.

According to one embodiment, which can be combined with one or more previous embodiments, the method further includes caching additional memory storage devices in the source computing system in the copy of the persistent cache disk generated in the second virtual machine in the target computing system. This feature leverages the availability of the virtual persistent memory to carry cache data from different storage sources to the target system.

According to one embodiment, which can be combined with one or more previous embodiments, the method further includes de-configuring, from the first virtual machine, the persistent cache disk that was generated using the non-volatile memory express protocol and the virtual persistent memory device. By de-configuring the persistent cache disk, a clean-up feature is provided that frees up data storage space within the source computing system once migration is done.

According to one embodiment, which can be combined with one or more previous embodiments, the data storage device is one of a hard disk, flash memory, or solid-state drive.

According to one embodiment, a source computing system includes a processor operating a hypervisor and a first virtual machine. A memory is coupled to the processor. The memory stores instructions to cause the processor to perform acts comprising caching a data storage in the source computing system using a non-volatile memory express protocol. The source computing system includes a first virtual machine. A target computing system is identified for migration of the first virtual machine to a second virtual machine in the target computing system. A virtual persistent memory device is provided to the first virtual machine. A persistent cache disk associated with the first virtual machine is generated. The cache content in the persistent cache disk is generated using the non-volatile memory express protocol. The cache content of the persistent cache disk that was generated using the non-volatile memory express protocol is migrated to the virtual persistent memory device. A copy of the virtual persistent memory device is migrated to a copy of the persistent cache disk generated in a second virtual machine in the target computing system.

According to one embodiment, which can be combined with one or more previous embodiments, the instructions cause the processor to perform further acts including a hypervisor in the source computing system providing memory pages backing up an instance of the virtual persistent memory device. The backup instance of the virtual persistent memory device provides a safeguard against losing the cache during migration as well as a source for accessing the cache data during migration.

According to one embodiment, which can be combined with one or more previous embodiments, the migration of the cache content of the persistent cache disk to the virtual persistent memory device occurs during the migration of the copy of the virtual persistent memory device to the copy of the persistent cache disk generated in the second virtual machine in the target computing system. In this manner, the cache data is preserved and the risk of loss on the source side is minimized.

According to one embodiment, which can be combined with one or more previous embodiments, the instructions cause the processor to perform further acts including caching additional memory storage devices in the source computing system in the copy of the persistent cache disk generated in the second virtual machine in the target computing system. This feature leverages the availability of the virtual persistent memory to carry cache data from different storage sources to the target system.

According to one embodiment, which can be combined with one or more previous embodiments, the instructions cause the processor to perform further acts including de-configuring, from the first virtual machine, the persistent cache disk that was generated using the non-volatile memory express protocol and the virtual persistent memory device. By de-configuring the persistent cache disk, a clean-up feature is provided that frees up data storage space within the source computing system once migration is done.

The subject technology incorporates the use of virtual persistent memory in the migration process of virtual machines so that cached data is retained when using the NVMe protocol during the migration operation. In one embodiment, during the migration phase, cached data of a Non-Volatile Memory Express (NVMe) supported device will be copied to a newly created virtual Persistent memory (vPMEM). The virtual Persistent memory(vPMEM) and its cache data content remain accessible to the target computing system during migration, even when the source computing system's cache memory device may be wiped clean.

Although reference is made to software embodiments, it should be noted that aspects of the software processes improve computing technology; namely the protection and retention of cached data during the migration of virtual machines. Accordingly, the teachings herein should not be considered abstract because aspects of the subject technology include virtual persistent memory, a technology that in this case, provides migration of cached data (which ius normally lost in a migration process) along with the migration of a virtual machine. By preserving cached data during the migration process, the operation of networks and computer servers using virtual machines is enhanced by improving memory resources and downtime that was up to now, necessary because cached data was lost during migration and was required to be replicated in a target system before the target system could be as fully functional as the source system.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one or more storage devices that may include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 includes an example of an environment for the execution of at least some of the computer code involved in performing the inventive methods, such as the improved migration code 200. The improved migration code 200 may include a virtual machine migration engine 240 that administers processes related to migrating a virtual machine from a source computing system to a target computing system. The virtual machine migration engine 240 may operate according to one or more of the methods disclosed in further detail below. In addition, migration code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and migration code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

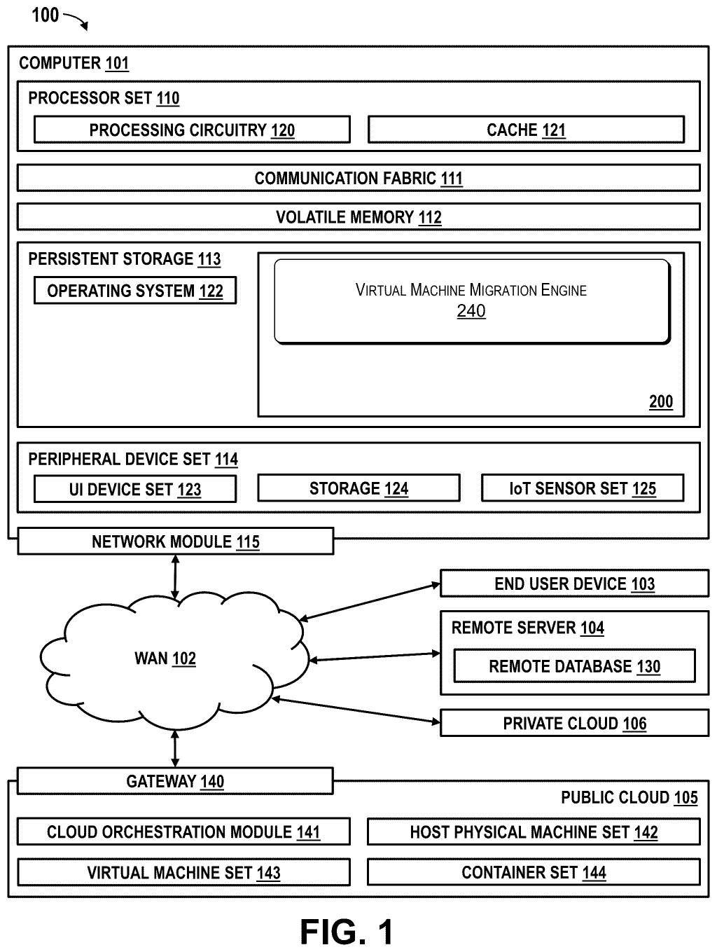

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. For the instant disclosure, the processor set 110 includes for example a central processing unit (CPU) and an accelerator. In some embodiments, a different type of processing element may be used instead of the CPU, (for example, a GPU or other process dedicated/specialized unit). Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in migration code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in migration code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System Architecture

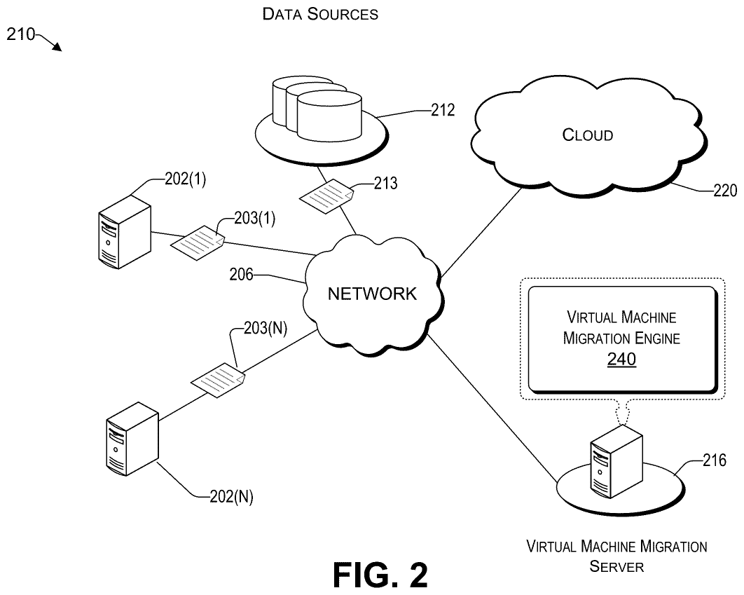

FIG. 2 illustrates an example architecture 210 for migration of virtual machines in a computing system of multiple computing devices. Architecture 210 includes a network 206 that allows various computing devices 202(1) to 202(N) to communicate with each other, as well as other elements that are connected to the network 206, such as data storage source 212, virtual machine migration server 216, and the cloud 220. The computing devices 202(1) to 202(N) and virtual machine migration server 216 may operate under the computing environment described above in FIG. 1. The virtual machine migration server 216 may operate the migration code 200, including the virtual machine migration engine 240. In the description that follows, references to a “source computing system, and a “target computing system” are represented by the computing devices 202(1) and 202(N).

Accordingly, the presence of the computing devices 202(1) to 202(N) imply that embodiments may include migration from a single “source computing system” to a single “target computing system”, multiple “source computing systems” to a single “target computing system”, and a single “source computing system” to multiple “target computing systems”. Likewise, any one or more of the computing devices 202(1) to 202(N) may have multiple data storage devices that may be used as sources for cached data in the source computing system or as eventual storage destinations for cached data in the target computing system. In some embodiments, the data storage sources 212 may be of different types including for example, hard disk drives, flash memory, and solid-state drives.

The network 206 may be, without limitation, a local area network (“LAN”), a virtual private network (“VPN”), a cellular network, the Internet, or a combination thereof. For example, the network 206 may include a mobile network that is communicatively coupled to a private network, sometimes referred to as an intranet that provides various ancillary services, such as communication with various application stores, libraries, and the Internet. The network 206 allows the virtual machine migration engine 240, which is a software program running on the virtual machine migration server 216, to communicate with the data source(s) 212, computing devices 202(1) to 202(N), and/or the cloud 220, to provide data processing related to migration of virtual machines. The data source(s) 212 may in some embodiments, represent cache storage devices or virtual memory devices. In some embodiments, a data packet 213 may be received by the virtual machine migration engine 240 that includes cached data that is stored in a virtual persistent memory format. This data packet 213 can be received by the virtual machine migration engine 240 by either a push operation from the data source(s) 212 or from a pull operation of the virtual machine migration engine 240. In one embodiment, the data processing for the virtual machine migration engine 240 is performed at least in part on the cloud 220.

Aspects of the symbolic sequence data (e.g., 203(1) and 203(N)) may be communicated over the network 206 with the virtual machine migration engine 240. Today, the computing devices 202(1) to 202(N) typically take the form of computer servers but in some embodiments, the computing devices 202(1) to 202(N) may represent end user devices (for example, computing devices accessed to perform admin duties on a network, which may include migration and administering oversight of virtual machines), such as desktop computers, portable handsets, smart-phones, tablet computers, personal digital assistants (PDAs), and smart watches, although they may be implemented in other form factors, including consumer, and business electronic devices. While the data source 212 and the virtual machine migration engine 240 are illustrated by way of example to be on different platforms, it will be understood that in various embodiments, the data source 212 and the virtual machine migration server 216 may be combined. In other embodiments, these computing platforms may be implemented by virtual computing devices in the form of virtual machines or software containers that are hosted in a cloud 220, thereby providing an elastic architecture for processing and storage.

### Example Migration Architecture

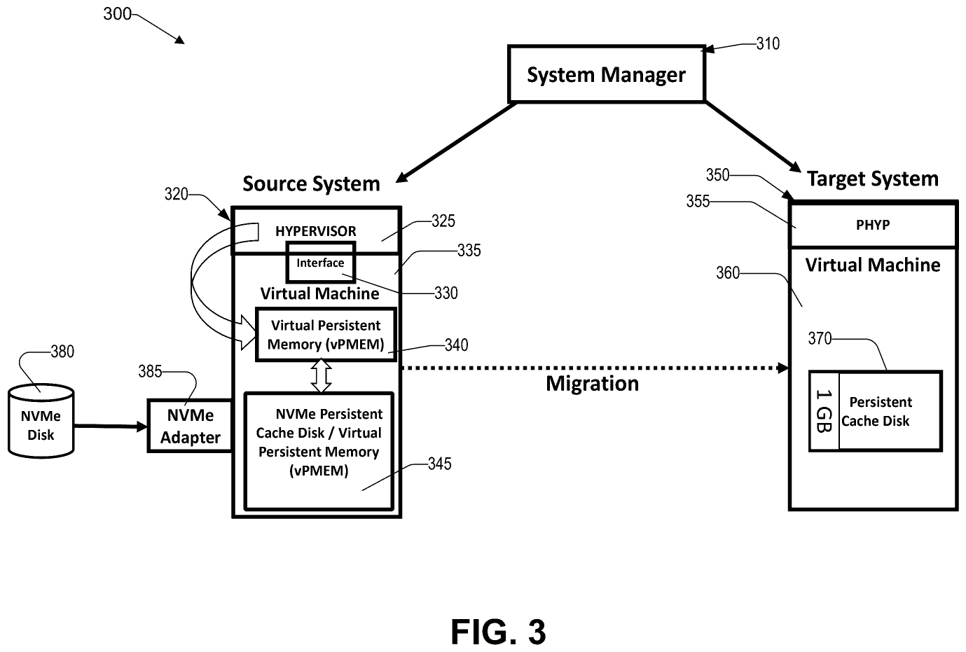

FIG. 3 shows a system 300 for migration of virtual machines according to an illustrative embodiment. In some embodiments, the system 300 includes a system manager 310 that coordinates a migration process between a source computing system 320 and a target computing system 350. The source computing system 320 may include a hypervisor 325 and a virtual machine 335. The virtual machine 335 may be configured to operate under the Non-Volatile Memory Express (NVMe) protocol. Some embodiments of the source computing system 320 may include a NVMe adapter 385 (which may be hardware) to process data stored in a disk 380 under the NVMe format.

During a migration validation phase, a privileged hypervisor software interface 330 may check if caching is enabled through Non-Volatile memory express on the virtual machine 335 being migrated. The privileged hypervisor software interface 330 requests the hypervisor 325 to provide a new virtual Persistent memory (vPMEM) device 340 to the virtual machine 335. A persistent cache disk 345 instance may be generated. The persistent cache disk 345 instance may be generated under the NVMe protocol. The persistent cache disk 345 may be configured to store cache data content using the vPMEM device 340. The cached data under the NVMe protocol is moved into the virtual persistent memory within the persistent cache disk 345.

The target computing system 350 may have its own hypervisor 355 and a virtual machine 360. The migration process from the source computing system 320 may preserve the cache data content of the persistent cache disk 345 that was generated using the non-volatile memory express protocol since the content in the virtual persistent memory device 340 remains accessible during migration. A copy of the virtual persistent memory device 340 may be migrated to a copy of the persistent cache disk (numbered as 370 to distinguish the copy from the original persistent cache disk 345 instance) generated in the second virtual machine 360.

### Example Migration Methodology

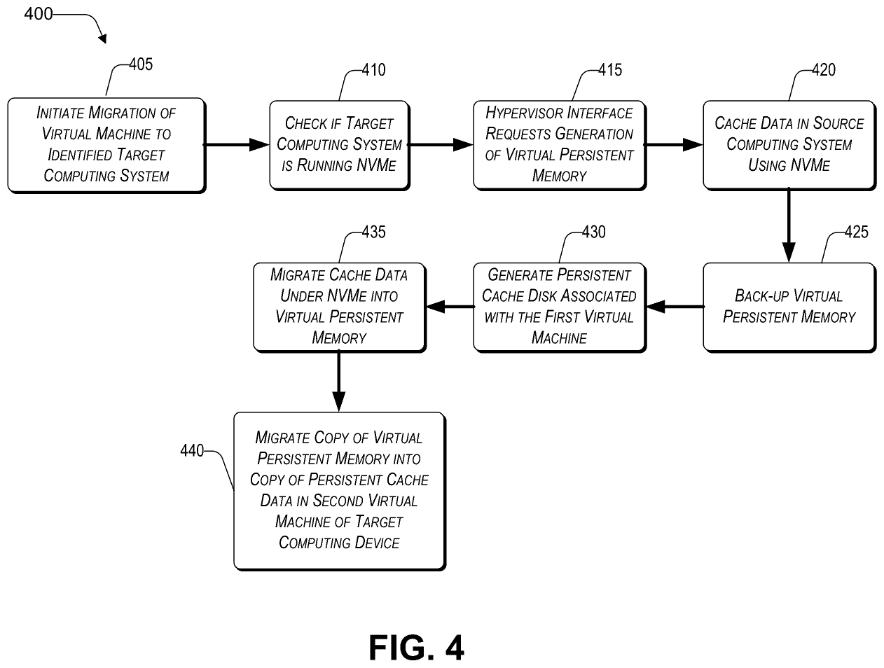

FIG. 4 shows a method 400 for migration of a virtual machine according to an embodiment. The method 400 may be described with reference back to elements in FIG. 3. The method 400 retains the cache state of virtual machine data storage devices (for example, hard disk drives) using a persistent memory disk 340. On migration initiation (block 405), the virtual machine 335 of the source computing system 320 may be migrated to a target computing system 350 that does not necessarily operate using nonvolatile memory express. For example, during Live Partition Mobility (LPM), validation of the virtual machine 360 of the target computing system 350 may confirm that the virtual machine 360 is not operating a Non-Volatile Memory Express (NVMe) cache device (block 410). In block 415, a system privileged hypervisor software interface 330 of the source computing system 320 may be configured to request generation of a virtual persistent memory device 340. The hypervisor 325 of the source computing system 320 may configure the virtual persistent memory device 340 for migration to the virtual machine 360 in the target computing system 350. Data content in a data storage device (for example, hard disk 380, whose data may be formatted under the NVMe protocol) may be cached (block 420). In some embodiments, the hypervisor 325 provides memory pages for backing up the virtual persistent memory instance from the available memory in the virtual machine 335 or memory from the source computing system's available/free memory pool (block 425). A persistent cache disk 345 associated with the first virtual machine is generated (block 430). The cache content in the persistent cache disk 345 is generated using the non-volatile memory express protocol. While migration is in progress the contents of the cache pool and its cache partition data (collectively, “cache content”) present in the persistent cache disk 345 that was generated using the non-volatile memory express protocol is migrated into the virtual persistent memory device 340 (block 435). A copy of the virtual persistent memory device is migrated to a copy of the persistent cache disk generated in a second virtual machine in the target computing system (block 440).

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer program product for virtual machine migration, the computer program product comprising a computer readable storage medium having program instructions embodied therewith, wherein an execution of the program instructions by a processor cause a computing device to:
in a source computing system with a first virtual machine, cache a data storage device in the source computing system, using a non-volatile memory express protocol;
identify a target computing system for migration of the first virtual machine to a second virtual machine in the target computing system;
provide a virtual persistent memory device to the first virtual machine;
generate a persistent cache disk associated with the first virtual machine, wherein cache content in the persistent cache disk is generated using the non-volatile memory express protocol;
migrate the cache content of the persistent cache disk that was generated using the non-volatile memory express protocol, to the virtual persistent memory device; and
migrate a copy of the virtual persistent memory device to a copy of the persistent cache disk generated in the second virtual machine in the target computing system.

2. The computer program product of claim 1, wherein the execution of the program instructions further causes the computing device to provide, by a hypervisor in the source computing system, memory pages backing up an instance of the virtual persistent memory device.

3. The computer program product of claim 1, wherein the migration of the cache content of the persistent cache disk to the virtual persistent memory device occurs during the migration of the copy of the virtual persistent memory device to the copy of the persistent cache disk generated in the second virtual machine in the target computing system.

4. The computer program product of claim 1, wherein the execution of the program instructions further causes the computing device to cache additional memory storage devices in the source computing system in the copy of the persistent cache disk generated in the second virtual machine in the target computing system.

5. The computer program product of claim 1, wherein the execution of the program instructions further causes the computing device to de-configure, from the first virtual machine, the persistent cache disk that was generated using the non-volatile memory express protocol and the virtual persistent memory device.

6. The computer program product of claim 1, wherein the execution of the program instructions further causes the computing device to:
determine whether the target computing system is running the non-volatile memory express protocol prior to migrating the copy of the virtual persistent memory device to the copy of the persistent cache disk generated in the second virtual machine in the target computing system; and
identify another target computing system on a condition that the target computing system is running the non-volatile memory express protocol.

7. The computer program product of claim 1, wherein the data storage device is one of a hard disk, flash memory, or solid-state drive.

8. A computer implemented method for virtual machine migration, comprising:
in a source computing system with a first virtual machine, caching a data storage device in the source computing system, using a non-volatile memory express protocol;
identifying a target computing system for migration of the first virtual machine to a second virtual machine in the target computing system;
providing a virtual persistent memory device to the first virtual machine;
generating a persistent cache disk associated with the first virtual machine, wherein cache content in the persistent cache disk is generated using the non-volatile memory express protocol;
migrating the cache content of the persistent cache disk that was generated using the non-volatile memory express protocol, to the virtual persistent memory device; and
migrating a copy of the virtual persistent memory device to a copy of the persistent cache disk generated in a second virtual machine in the target computing system.

9. The method of claim 8, further comprising providing, by a hypervisor in the source computing system, memory pages backing up an instance of the virtual persistent memory device.

10. The method of claim 8, wherein the migration of the cache content of the persistent cache disk to the virtual persistent memory device occurs during the migration of the copy of the virtual persistent memory device to the copy of the persistent cache disk generated in the second virtual machine in the target computing system.

11. The method of claim 8, further comprising caching additional data storage devices in the source computing system in the copy of the persistent cache disk generated in the second virtual machine in the target computing system.

12. The method of claim 8, further comprising de-configuring, from the first virtual machine, the persistent cache disk that was generated using the non-volatile memory express protocol and the virtual persistent memory device.

13. The method of claim 8, further comprising:
determining whether the target computing system is running the non-volatile memory express protocol prior to migrating the copy of the virtual persistent memory device to the copy of the persistent cache disk generated in the second virtual machine in the target computing system; and
identifying another target computing system on a condition that the target computing system is running the non-volatile memory express protocol.

14. The method of claim 8, wherein the data storage device is one of a hard disk, flash memory, or solid-state drive.

15. A source computing system, comprising:
a processor operating a hypervisor and a first virtual machine; and
a memory coupled to the processor, the memory storing instructions to cause the processor to perform acts comprising:
caching a data storage device in the source computing system, using a non-volatile memory express protocol;
identifying a target computing system for migration of the first virtual machine to a second virtual machine in the target computing system;
providing a virtual persistent memory device to the first virtual machine;
generating a persistent cache disk associated with the first virtual machine, wherein cache content in the persistent cache disk is generated using the non-volatile memory express protocol;
migrating the cache content of the persistent cache disk that was generated using the non-volatile memory express protocol, to the virtual persistent memory device; and
migrating a copy of the virtual persistent memory device to a copy of the persistent cache disk generated in a second virtual machine in the target computing system.

16. The source computing system of claim 15, wherein the instructions cause the processor to perform further acts comprising providing, by the hypervisor, memory pages backing up an instance of the virtual persistent memory device.

17. The source computing system of claim 15, wherein the migration of the cache content of the persistent cache disk to the virtual persistent memory device occurs during the migration of the copy of the virtual persistent memory device to the copy of the persistent cache disk generated in the second virtual machine in the target computing system.

18. The source computing system of claim 15, wherein the instructions cause the processor to perform further acts comprising caching additional data storage devices in the source computing system in the copy of the persistent cache disk generated in the second virtual machine in the target computing system.

19. The source computing system of claim 15, wherein the instructions cause the processor to perform further acts comprising de-configuring, from the first virtual machine, the persistent cache disk that was generated using the non-volatile memory express protocol and the virtual persistent memory device.

20. The source computing system of claim 15, wherein the instructions cause the processor to perform further acts comprising:
determining whether the target computing system is running the non-volatile memory express protocol prior to migrating the copy of the virtual persistent memory device to the copy of the persistent cache disk generated in the second virtual machine in the target computing system; and
identifying another target computing system on a condition that the target computing system is running the non-volatile memory express protocol.
